(19) United States
(12) Patent Application Publication
(10) Pub. No.: US 2017/0019982 A1
(43) Pub. Date: Jan. 19, 2017

(54) METHOD, APPARATUS AND SYSTEM FOR PROVIDING MULTIPLE EUV BEAMS FOR SEMICONDUCTOR PROCESSING

(71) Applicant: GLOBALFOUNDRIES Inc., Grand Cayman (KY)

(72) Inventors: Erik Robert Hosler, Cohoes, NY (US); Moseh Preil, Sunnyvale, CA (US)

(73) Assignee: GLOBALFOUNDRIES Inc., Grand Cayman (KY)

(21) Appl. No.: 14/803,068

(22) Filed: Jul. 18, 2015

(51) Int. Cl. H05G 2/00; G21K 5/08

(52) U.S. Cl. CPC H05G 2/006; G21K 5/08; H05G 2/008

(57) ABSTRACT

At least one method, apparatus and system for providing a plurality of optical beams, such as EUV beams. A first electron beam is received. The first electron beam is converted into at least a second electron beam and a third electron beam. The second and third second and third electron beams to an undulator. Using the undulator for generating a plurality of output beams using the at least second and third electron beams. The output beams respectively comprises a plurality of optical beam components and a plurality of electron beam component. A first optical beam component of the plurality of optical beam components is provided to a first processing tool.

### FIELD OF THE INVENTION

Generally, the present disclosure relates to using electron optics and magnets for the manufacture of sophisticated semiconductor devices using, and, more specifically, to various methods and structures for providing an EUV beam for semiconductor wafer lithography and metrology.

### DESCRIPTION OF THE RELATED ART

The technology explosion in the manufacturing industry has resulted in many new and innovative manufacturing, testing, and analysis processes. Today's manufacturing processes, particularly semiconductor manufacturing processes, call for a large number of important steps as well as analysis of the results of the manufacturing processes. These process and analyses steps are usually important, and therefore, require a number of inputs that are generally fine-tuned to maintain proper manufacturing control.

The manufacture of semiconductor devices requires a number of discrete process steps to create a packaged semiconductor device from raw semiconductor material. The various processes, from the initial growth of the semiconductor material, the slicing of the semiconductor crystal into individual wafers, the fabrication stages (etching, doping, ion implanting, photolithography, or the like), to the packaging and final testing of the completed device, are so different from one another and specialized that the processes may be performed in different manufacturing locations that contain different control schemes.

Generally, a set of processing steps is performed on a group of semiconductor wafers, sometimes referred to as a lot, using semiconductor-manufacturing tools, such as an exposure tool or a stepper/scanner. Photolithography processes are an important part of forming geometric patterns on a semiconductor wafer. Often ultraviolet (UV) and longer wavelength light sources are used to create geometric patterns on a photoresist layer on a semiconductor substrate through a masking layer that defines these patterns. State of the art photolithography processes include using argon-fluoride lasers to generate UV light for generating patterns on the substrate. The masking layers, called reticles or masks, are used to define the pattern on the semiconductor wafer. It is desirable that the mask metrology is performed prior to any exposure to light for defects to confirm defect free printability. Typically this is also done at the exposure wavelength used to print the semiconductor wafer. Further, metrology data acquisition and analysis are performed following the photolithography processes.

Light sources providing sufficient power in the extreme ultraviolet (EUV) range are required to reduce the wavelength of light currently used in photolithography. Currently available lasers, e.g., argon-fluoride lasers, having sufficient power for HVM generally lack a natural active lasing medium to produce EUV light. As a result, designers have used micron scale tin (Sn) droplets that are super-radiated with a CO₂ laser at high (kilowatt) power. This generates highly-charged tin particles, accessing specific energy states that emit radiation at approximately 13.5 nanometers (nm). This emission process, known as laser-produced plasma (LPP), has the potential to provide an HVM compatible laser-like EUV light source. However, the state-of-the-art lacks an efficient means for producing HVM compatible EUV power for semiconductor manufacturing. Moreover, the prior art lacks an efficient methodology for utilizing emission generated by LPP sources for both lithography and high-resolution inspection/metrology.

Designers have suggested a single source, high-power free-electron laser (FEL) for use in photolithography processes in semiconductor wafer processing, however, the capability of such sources have not yet been harnessed. FIG. 1 illustrates a typical FEL source. FIG. 2 illustrates a typical superconducting accelerator of FIG. 1. Referring simultaneously to FIGS. 1 and 2, an electron injector 110 comprises an electron source (i.e., electron gun) and an short acceleration and beam conditioning assembly. The electron injector 110 defines various parameters of the generated electron bunches. The electron bunches are sent through n an accelerator unit 120 As shown in FIG. 2, the superconducting accelerator unit 120 contains a 1^{st} through N^{th} superconducting radio frequency (SRF) cavities 210-230. The series of SRF cavities 210-230 accelerate the electron bunches to relativistic velocities.

Upon accelerating the electron bunches to relativistic velocities, the electron bunches are sent to an undulator 130. The undulator 130 comprises a plurality of strategically positioned magnets of alternating polarity. The undulator 130 is characterized by an undulator period (spacing between magnet pairs) and magnetic strength parameters. Electron bunches passing through the undulator 130 will oscillate according to the magnetic field, generating radiation that is proportional to the undulator period, undulator magnetic strength, and the electron beam energy provided by the SRF cavities. These parameters are chosen to yield a desired wavelength and therefore the undulator 130 is configured accordingly. After processing by the undulator 130, the co-propagating electron and radiation beams are sent to a separator 140, which separates the two beams. The electron beam at this point can either be directly disposed of in an electron beam dump 150, releasing all of its energy in the form of radiation and heat, or the electron beam can be sent to another acceleration unit or recirculated into the same acceleration unit as previously used to bring the electron beam to relativistic velocity. By decelerating the electron bunches in a second set (or same set, but out of phase of the accelerating bunches) of SRF cavities, the stored energy in an electron bunch can be extracted, decelerating the bunch, and used to accelerate subsequent electron bunches. The radiation generated in the undulator 130 through the FEL process, having been separated from the electron beam, is provided to a set of optics, potentially EUV optics 160, which then processes the radiation and provides radiation compatible with photolithography. Through this method FEL emission may then be used to perform lithography/metrology processing upon semiconductor wafers. In many cases the distance from the electron gun 110 and the separator 140 may be approximately 100 meters.

FIG. 3 illustrates a stylized depiction of a prior art multi-pass accelerator of an accelerator unit of a FEL source. An accelerator unit 310 would replace the superconducting accelerator unit 120 in FIG. 1. The multi-pass accelerator 310 includes a circulating electron path 330 that comprises a plurality of bends. Electron bunches are accelerated to relativistic speed and that electrons from the path 330 is provided to an undulator.

Among the problems associated with using EUV beams for semiconductor processing are the complexities and losses in distributing EUV beams to various targets, such as lithography scanners, metrology tools, etc. As described below, designers have proposed various EUV beam system designs for distributing EUV beams. However, these designs present various problems, including inefficiencies and accuracy issues. Using state-of-the-art designs, directing EUV light to targeted locations can be cumbersome and expensive to implement.

One system provided by designers for distributing EUV beams to multiple locations includes the use of multiple undulators. FIG. 4 illustrates a state-of-the-art design for using multiple undulators using an undulator switchyard system. The system 400 of includes a plurality of undulators (a 1^{st} undulator 410 through a 4^{th} undulator 440). An accelerator unit 120 provides an electron beam 405 to a network of switches 460 of the switchyard. The switches 460 guide a portion of the electron beam 405 to the undulators 410-440.

For example, a portion of the electron beam 405 is guided to the 1^{st} undulator 410, which produces a FEL beam 435A, which may be provided to a target (e.g., a scanner). At the same time, another portion of the electron beam 405 is bypassed around the 1^{st} undulator 410 and instead, is sent to the 2^{nd} undulator 420. The 2^{nd} undulator 420 generates another FEL beam 435B, which is provided to another target. Similarly, a portion of the electron beam 405 is provided to the 3^{rd} undulator 430, which generates another FEL beam 435C that is provided to another target.

The network of switches 460 in the switchyard guide another portion of the electron beam 405 to the 4^{th} undulator 440, which generates yet another FEL beam 435D that is sent to another target. The switchyard may then guide the redirected electron bunches from the undulators 410-440 and/or the redirected electron bunches to an electron beam dump 470. In this manner a plurality of targets (e.g. FEL scanners) may be provided with FEL beams from undulators. However, this configuration requires a dedicated undulator for each target, which can be prohibitably costly and very complex to implement. The complexity of controlling various switches to direct electron beams to various undulators is very complex and costly. Further, each undulator themselves can be very costly. This configuration for a semiconductor fab can be too costly and impractical to implement.

Another implementation that has been suggested is a time-multiplexing FEL beam source that uses rotating insertion mirrors. FIG. 5 illustrates a stylized depiction of a time-multiplexing EUV beam system that includes rotating mirrors. An EUV beam 510 generated by an undulator is provided to a series of rotating insertion mirrors (1^{st} mirror 520, 2^{nd} mirror 530, and 3^{rd} mirror 540). The mirrors 520-540 are configured in series, wherein the EUV beam 510 is capable of passing through the mirrors 520-540 at different time periods.

Each of the mirrors 520-530 are generally round in shape and contain a slot that allows the EUV beam 510 to pass through, as stylistically depicted by the images represented by the reference numbers 525, 535 and 535. The reference numbers 525, 535 and 535 represent respective top views of the mirrors 520, 530, and 540. Due to the slots, which rotate and come into the path of the EUV beam 510 at different time periods, the EUV are allowed to proceed through each of the mirrors 520-540 at certain time period, and is reflected to a target at other time periods. For example, at a first time period, the EUV beam 510 is reflected to a target application due to the rotation of the mirror 520. At a second time period, the EUV beam 510 is allowed to pass through the 1^{st} mirror 520 (via its slot) and is reflected by the 2^{nd} mirror 530 to another target. At a third time period, the EUV beam 510 is allowed to pass through the 1^{st} mirror 520 and the 2^{nd} mirror 530 (via their respective slots) and is reflected by the 3^{rd} mirror 540 to yet another target.

As one can imagine, this coordination of passing the EUV beam 510 through in some cases and reflecting the beam 510 in other cases requires very intricate timing and coordination, which can be very complex and is difficult to implement. In order to provide sufficient EUV beam energy to multiple targets (e.g., scanners) at sufficient frequencies requires fast movements (i.e. spinning of the mirrors) to position the slots of the mirrors 520-540 at precisely correct alignments and timing. This requires the mechanical system that spins the mirrors 520-540 to function with extreme precision, wherein the slightest deviation may lead to the delivery of EUV beams to the scanners being compromised. The required timing and precision can cause this system to be error prone, particularly, the EUV beams may strike the edge of the mirror where it inherently has bigger losses. Additional problems could be caused in terms of beam stability and quality due to the flatness and curvature of the rotating mirrors. Further, only one endpoint device (i.e., tool) can be powered at one time period, and thus, the mirror assembly is required to be very fast moving and accurate, making the timing of the operation of this system more critical and subject to errors. Such a precise and fast moving mirror assembly, along with near perfect coordination and timing required to direct the EUV beam to precise locations is extremely difficult and impractical to implement into a semiconductor fab.

Another implementation for providing light energy to multiple locations that has been suggested is a split-edge mirror-assembly. FIG. 6 illustrates a state-of-the-art split-edge mirror assembly that is capable of providing light energy to a plurality of locations. A light beam 610 of a width “W” is provided to a plurality of mirrors (1^{st} mirror 620A through n^{th} mirror 620N). The 1^{st} through n^{th} mirrors 620A-620N are positioned generally in series, in line with the light beam 610.

The 1^{st} through n^{th} mirrors 620A-620N are arranged at varying angles such that a portion of the light beam 610 is directed to a corresponding target. The 1^{st} mirror 620A splits the light beam 610 and directs a portion of the beam 610 to a 1^{st} target 630. The remaining portion of the beam 610 that was not split off and reflected away by the 1^{st} mirror 620A travels onwards to subsequent mirrors, wherein each subsequent mirror splits off a portion of beam 610 and reflects that portion to a corresponding target. The subsequent mirrors are horizontally and vertically positioned to split off respective portions of the beam 610 and direct them to respective targets. Finally, the last portion of the beam 610 is reflected by the n^{th} mirror 620N towards the n^{th} target 630N.

One of the problems associated with the split edge mirror system is that the edge portion of the 1^{st} through n^{th} mirrors 620A-620N are generally not fully polished as a result of state-of-the-art manufacturing processes for providing beam-directing mirrors. As such, a large amount of losses are incurred due to the imperfections of the edges of the 1^{st} through n^{th} mirrors 620A-620N. Further, removing small portion of the beam 610 has to be performed with extremely high precision regarding the arrangement of the mirrors of the system, and is subject to various errors. Accordingly, due to the difficulties in arranging and fabricating the various mirrors for performing split-edge beam delivery, and due to the inherent large losses, the split edge mirror system is difficult and impractical to implement into semiconductor fabs.

The present disclosure may address and/or at least reduce one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure is directed to various methods, apparatus and system for providing a plurality of optical beams for a semiconductor fab. At least one method, apparatus and system for providing a plurality of optical beams, such as EUV beams. A first electron beam is received. The first electron beam is converted into at least a second electron beam and a third electron beam. The second and third electron beams are provided to an undulator. Using the undulator for generating a plurality of output beams using the at least second and third electron beams. The output beams respectively comprises a plurality of optical beam components and a plurality of electron beam component. A first optical beam component of the plurality of optical beam components is provided to a first processing tool.

### BRIEF DESCRIPTION OF THE DRAWINGS

The disclosure may be understood by reference to the following description taken in conjunction with the accompanying drawings, in which like reference numerals identify like elements, and in which:

FIG. 1 illustrates a stylized depiction of a typical FEL source;

FIG. 2 illustrates a stylized depiction prior art superconducting accelerator of the FEL source of FIG. 1;

FIG. 3 illustrates a stylized depiction of a prior art multi-pass accelerator of a FEL source;

FIG. 4 illustrates a state-of-the-art design for using multiple undulators using an undulator switchyard system;

FIG. 5 illustrates a stylized depiction of a time-multiplexing EUV beam system that includes rotating mirrors;

FIG. 6 illustrates a state-of-the-art split-edge mirror assembly that is capable of providing light energy to a plurality of locations;

FIG. 7 illustrates a system 700 for generating a plurality of light beams and directing them to a plurality of targets, in accordance with embodiments herein;

FIG. 8 illustrates a more detailed depiction of the EUV beam unit of FIG. 7, in accordance with embodiments herein;

FIG. 9A illustrates a stylized block diagram depiction a possible electron beam source of FIG. 8 consisting of a multi-pass accelerator in accordance with embodiments herein;

FIG. 9B illustrates a stylized depiction of a the multi-pass accelerator of FIG. 9A, in accordance with embodiments herein;

FIG. 10 illustrates a stylized depiction of one embodiment of implementing the transversely elongated undulator system of FIG. 8;

FIG. 11 illustrates a stylized depiction of an alternative embodiment of implementing the transversely elongated undulator system of FIG. 8;

FIG. 12 illustrates a stylized depiction of a fab in accordance with the system of embodiments herein; and

FIG. 13 illustrates a stylized depiction of a system for providing an EUV beam for processing and inspecting semiconductor wafers, in accordance with embodiments herein.

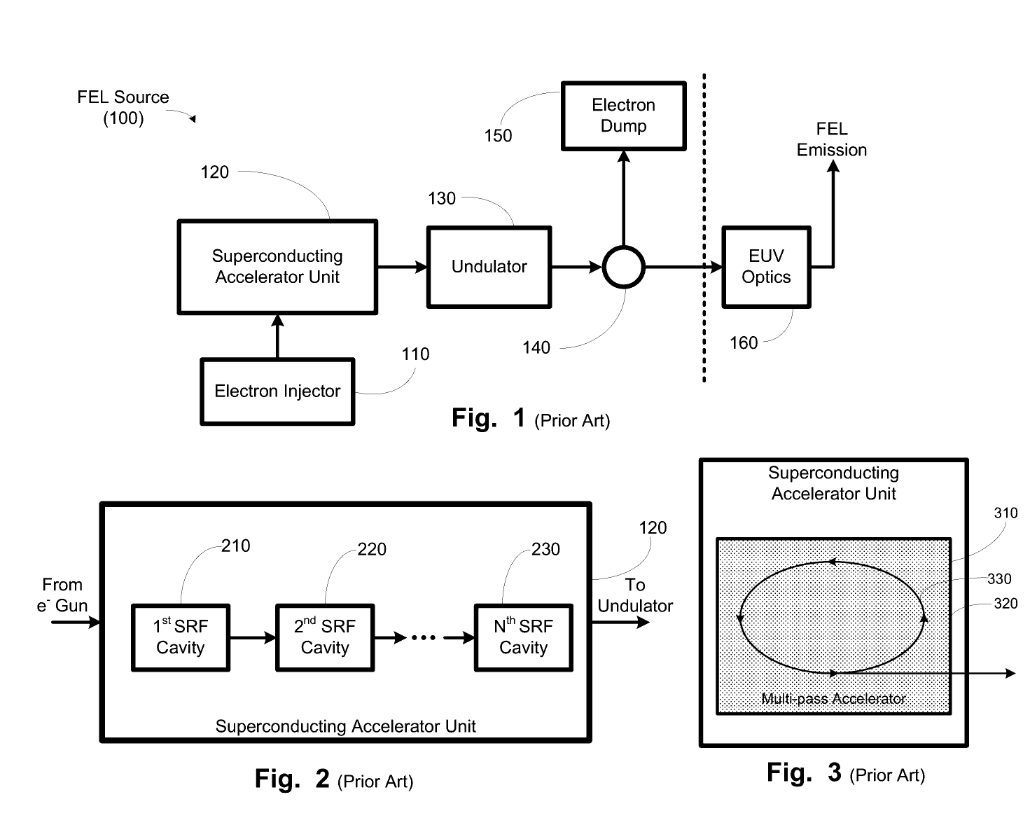

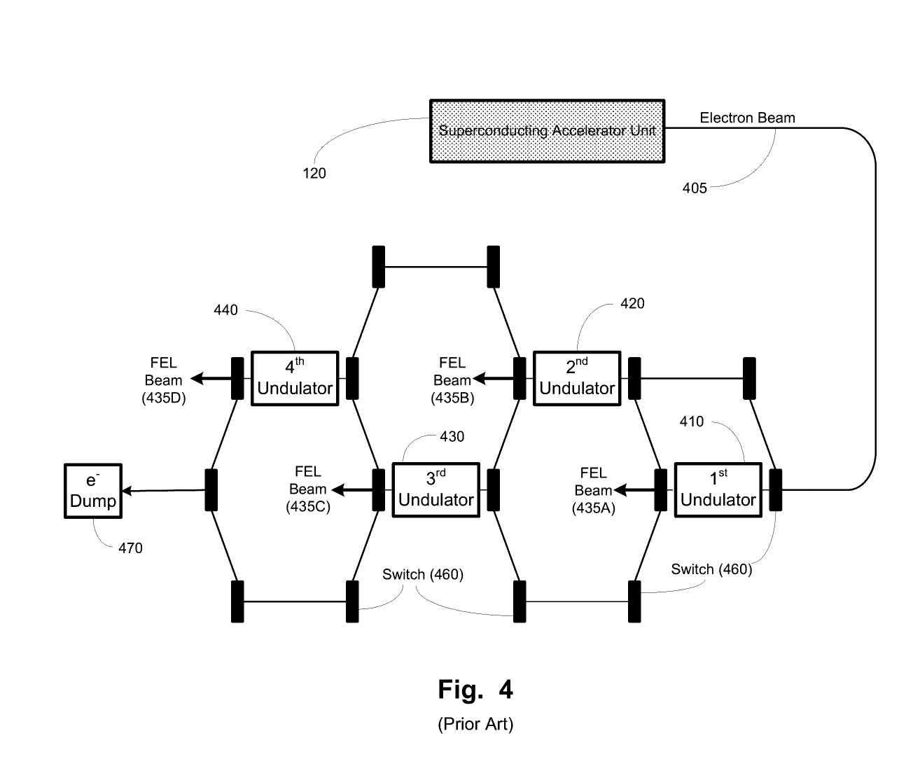

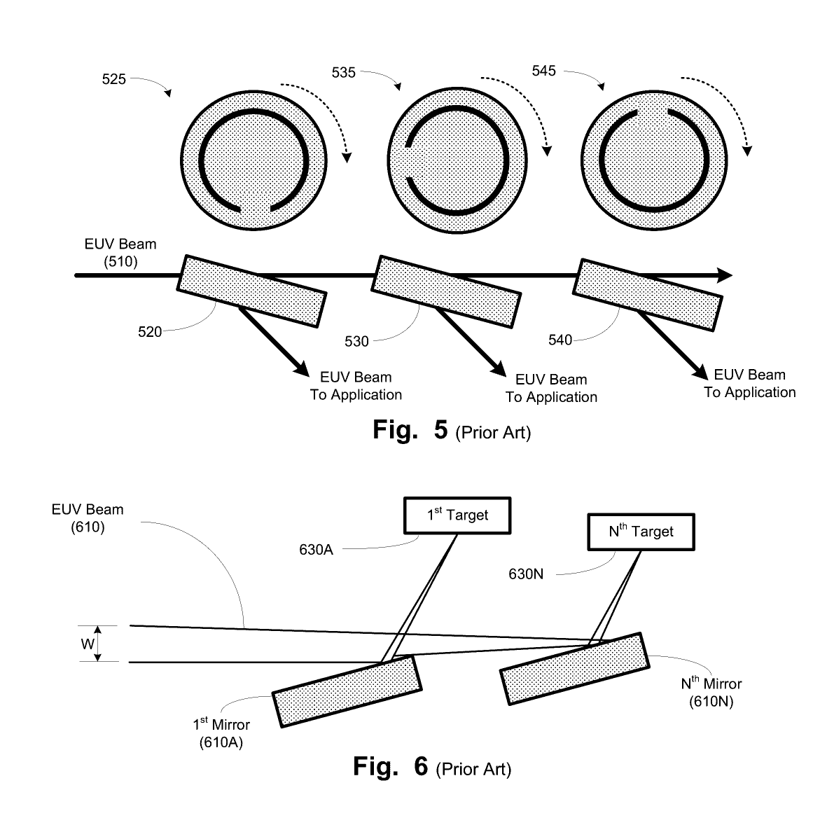

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached Figs. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein provide for generating a plurality of radiation beams (e.g., EUV beams) and directing them to a plurality of targets, such as light beam scanners (e.g., photolithography tools), optical-based metrology tools, etc. In one embodiment, a plurality of EUV beams may be generated from a single source of electron bunches. The plurality of EUV beams may be provided by a single undulator for generating a plurality of parallel EUV beams. These beams may then be directed to corresponding targets (e.g., optical scanners, optical metrology tools, etc.).

In some embodiments, a transversely elongated undulator, i.e. a magnet assembly elongated along the dimension perpendicular to the electron beam propagation trajectory, may be employed to generate a plurality of EUV beams from an equivalent plurality of electron beams traveling parallel relative to each. In some embodiments, dipole magnets may be advantageously arranged to variably bend the electron bunches, creating independent trajectories compatible with the eventual EUV beam targets for each bunch, and generate an equivalent plurality of EUV beams which may then be directed to a plurality of targets. In some embodiments, additional dipole magnets may be employed to separate the electron bunches from the EUV beams. The EUV beams may be directed to the targets, while the separated electron bunches may be dispositioned to either a beam dump or to an electron accelerator, wherein the electron beam energy can be recovered before the beam is dispositioned to an electron beam dump. In some embodiments, the electron accelerator which reclaims energy from the electron beam can be the same the electron beam source prior to the undulator. Although embodiments herein are described in terms of EUV beams for convenience, those skilled in the art would appreciate that embodiments herein may be implemented for a variety of types of light sources and remain within the spirit and scope of the present invention.

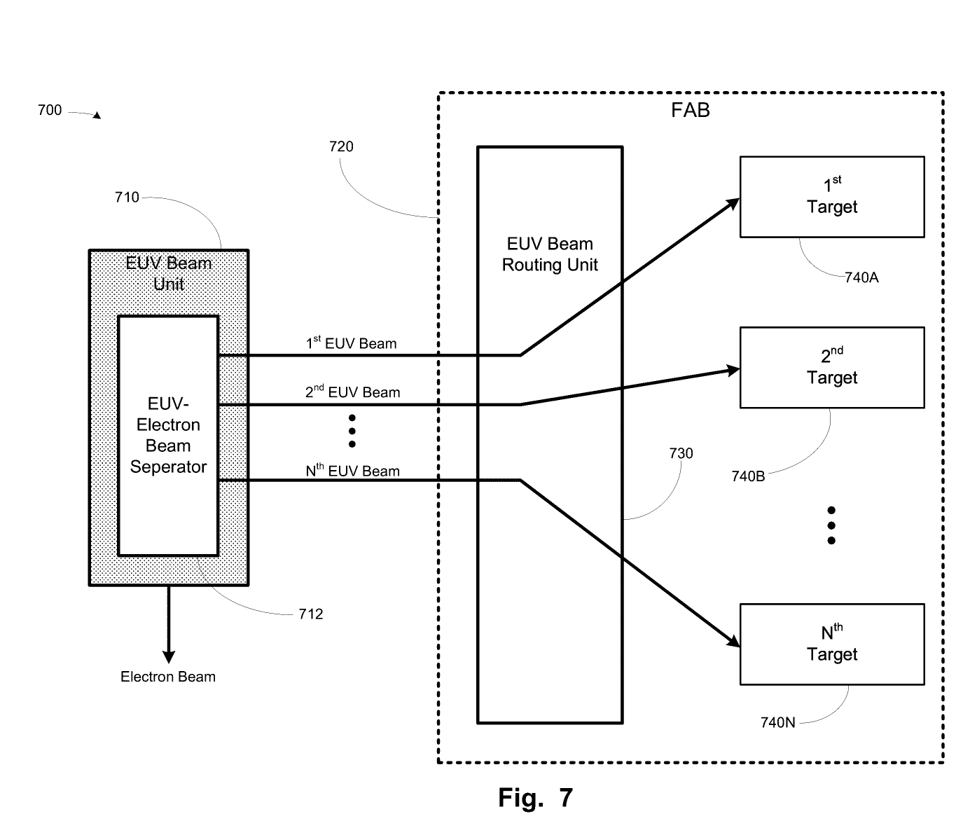

Turning now to FIG. 7, a system 700 for generating a plurality of light beams and directing them to a plurality of targets, in accordance with embodiments herein, is illustrated. The exemplary embodiment depicted by the system 700 is described in terms of EUV beams for ease of context and description, however, the system 700 may be directed to a variety of light sources of varying frequencies and power.

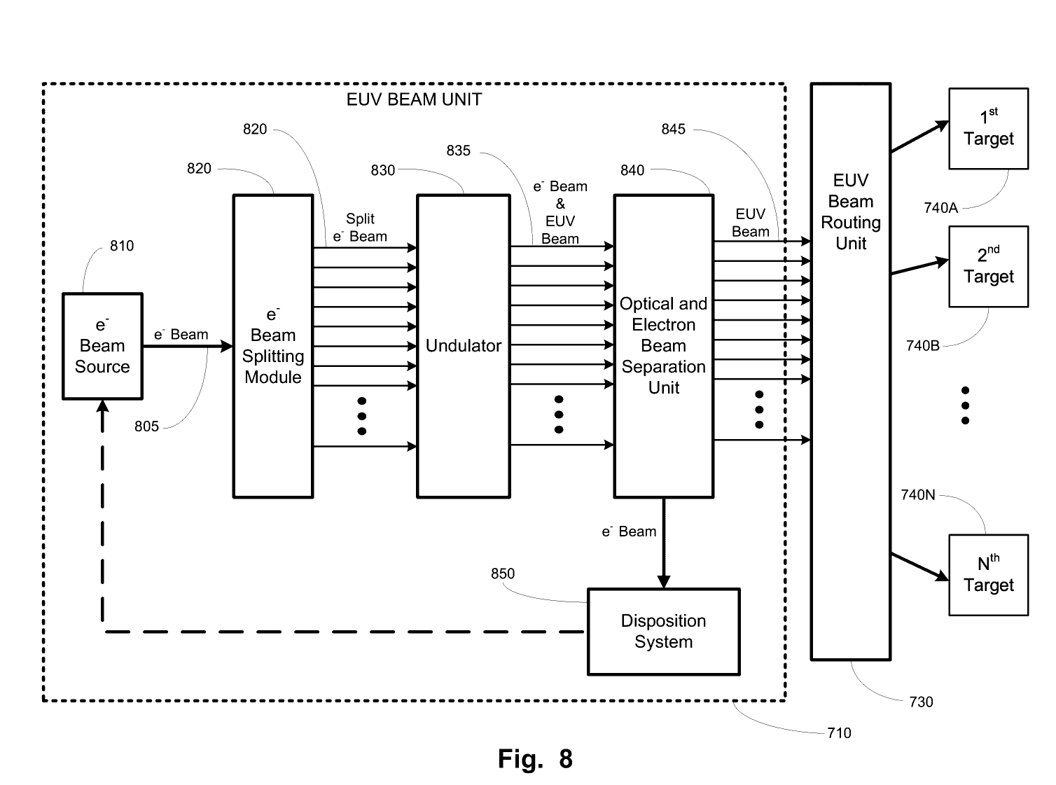

The system 700 comprises an EUV-electron beam separation unit 710 operatively coupled to an entity that utilizes EUV beams provided by the EUV beam unit 710, such as a fab 720 that is capable of manufacturing integrated circuits using semiconductor wafers. The EUV beam unit 710 may provide a plurality of EUV beams to the fab, e.g., a 1^{st} EUV beam, a 2^{nd} EUV beam through an N^{th} EUV beam. The EUV-electron beam separation unit 710 comprises a EUV-electron beam separator 712 capable of separating the electron and EUV beam so the electron beam can be dispositioned and the EUV passed to the EUV beam routing unit 730. It is more efficient to direct EUV beams of lower power and guide them to desired targets as compared to splitting an EUV beam having more power and then directing them to the desired targets. For example, it would be more efficient to provide ten EUV beams of 1 KW each and guiding them to desired targets, compared to providing one EUV beam of 10 KW and splitting that beam into ten portions and directing them to the targets. A more detailed illustration of the EUV beam unit 710 is provided in FIG. 8 and accompanying description below.

Continuing referring to FIG. 7, the fab 720 may comprise a plurality of targets, i.e., a 1^{st} target 740A, a 2^{nd} target 740B, through an N^{th} target 740N (collectively “targets 740”). Some of the targets 740 may be wafer processing tools that utilize light beams (e.g., EUV beams), such as photolithography tools. Some of the targets may be metrology tools that utilize light beams (e.g., EUV beams), such as optical metrology data acquisition tools.

The fab 720 may also comprise an EUV beam routing unit 730 that is capable of routing the 1^{st} through an N^{th} EUV beams respectively to the 1^{st} through an N^{th} targets 740. The EUV beam routing unit 730 may comprise various components that are capable of redirecting the 1^{st} through an N^{th} EUV beams to predetermined target 740.

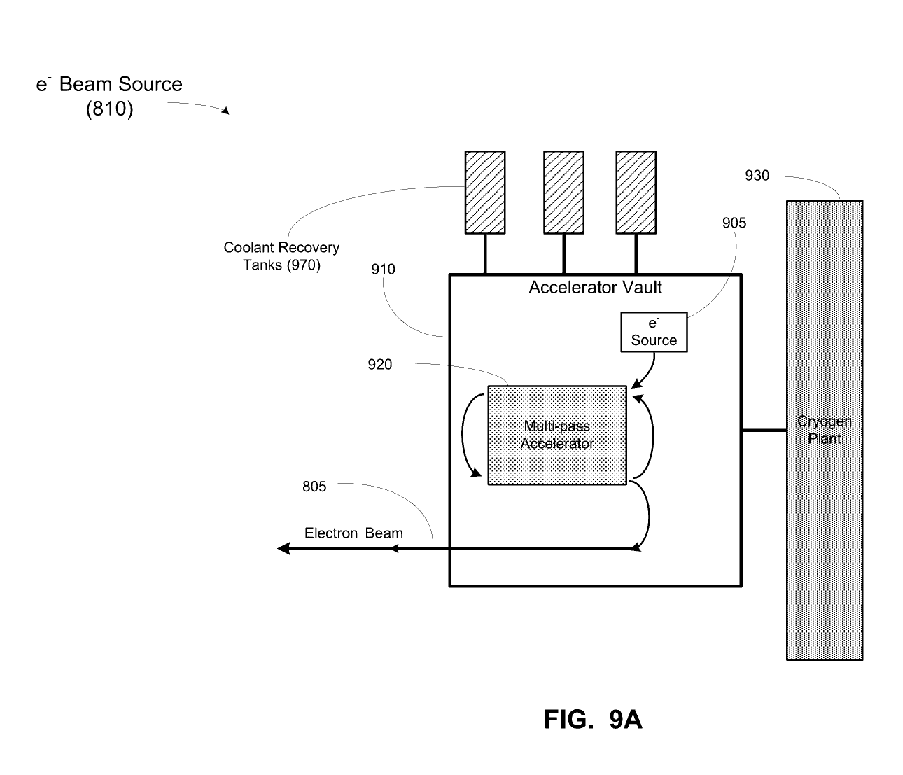

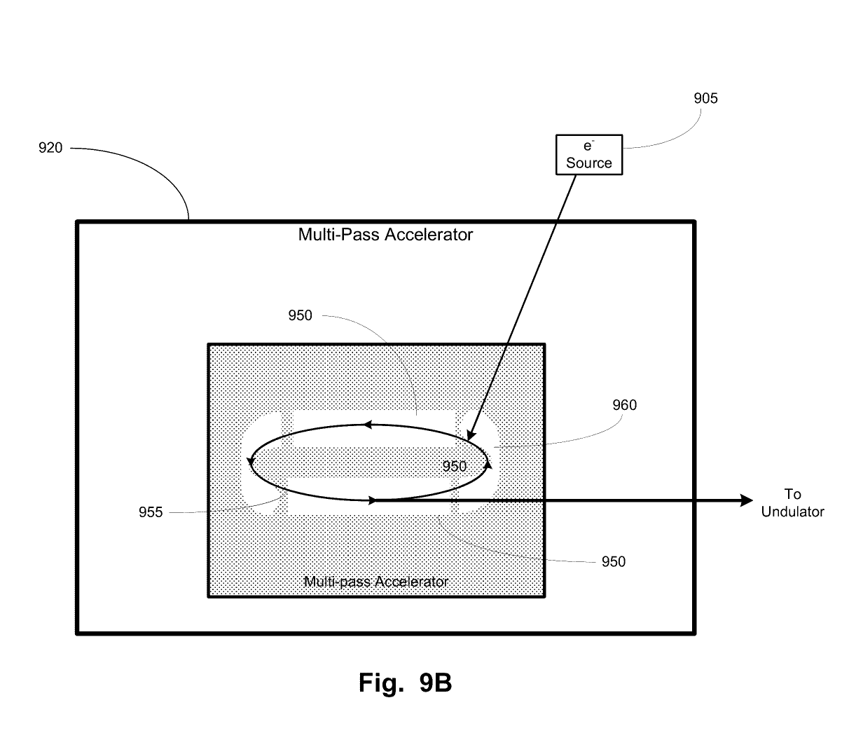

Turning now to FIG. 8, a more detailed depiction of the EUV beam unit 710 of FIG. 7, in accordance with embodiments herein is illustrated. The EUV beam unit 710 may comprise an electron beam source 810 that is capable of providing an electron beam 805. A more detailed description of a possible electron beam source 810 is provided in FIG. 9 and accompanying description below. The electron beam source 810, which may comprise an electron injector that defines various parameters for electron bunches that are generated by the source 810. The electron beam source 810 may also comprise an accelerator for generating the electron bunches. The electron bunches comprise an electron beam, wherein in some embodiments, the electron bunches may have roughly equivalent specifications (bunch length, charge, and spacing between bunches or groups of bunches). The EUV beam unit 710 may also comprise an electron beam splitting module 820, an undulator 830, a optical and electron separation unit 840, and a disposition system 850 configured to disposition the electron beam after the undulator 830. The disposition system may comprise an electron beam dump and/or a possibly recovery system to recover the electron beam energy 850. In one embodiment, the dashed line illustrated in FIG. 8 represents energy recovery provided into the same accelerator cavities.

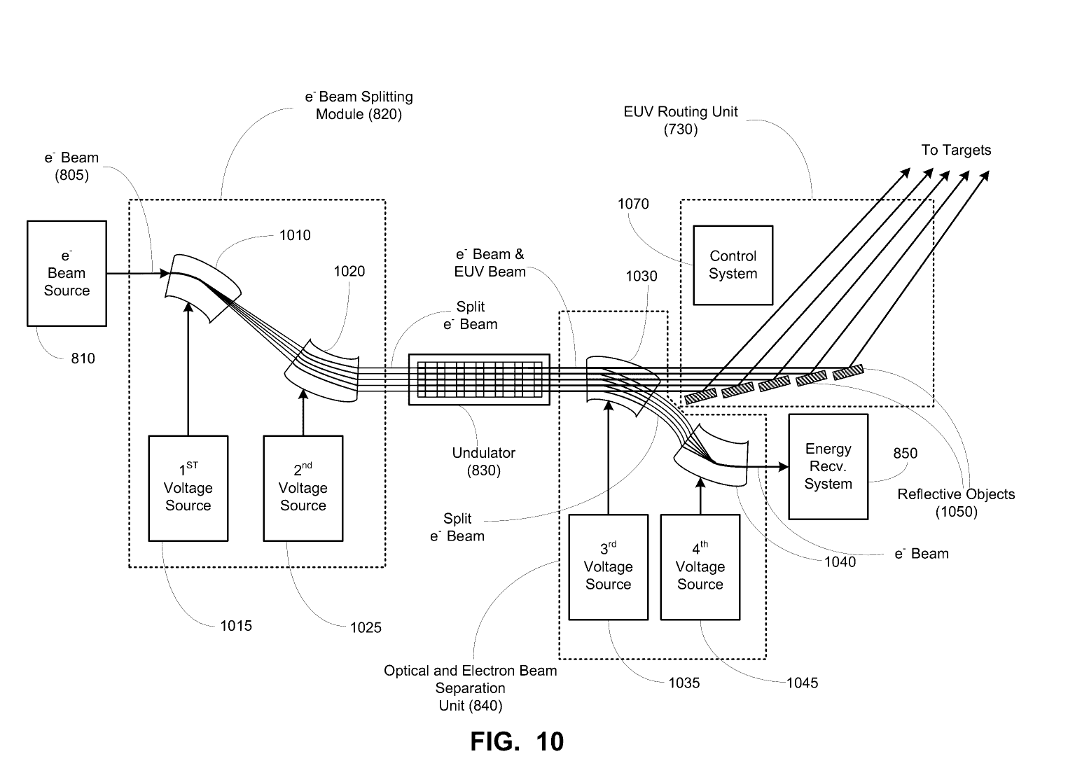

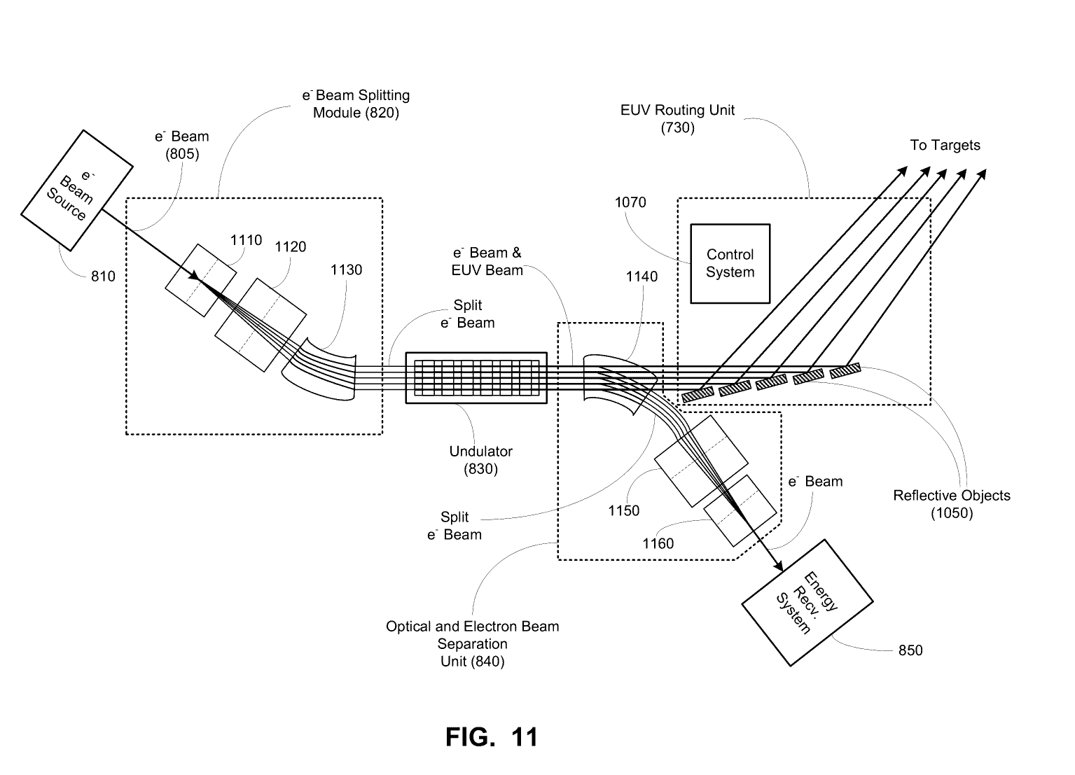

The electron beam 805 from the electron beam source 810 is provided to the electron beam splitting module 820. The electron beam splitting unit 820 is capable of splitting the electron beam 805 into multiple electron beams of smaller current. For example, the electron beam 805 may be a 10 mA electron beam that is split into ten 1 mA electron beams by the electron beam splitting unit 820. The output of the splitting unit 820 is a set of parallel electron beams 825. More detailed descriptions of the electron beam splitting unit 820 are provided in FIGS. 10 and 11, as well as their respective accompanying descriptions below.

Continuing referring to FIG. 8, the plurality of electron beams from the electron beam splitting unit 820 may be provided to the undulator 830. The undulator 830 comprises a plurality of strategically positioned magnets of alternating polarity in the traditional sense of an undulator. The undulator 830 may be elongated along the transverse axis relative to the traversing electron beams. In one embodiment, the magnetic field strength is homogenous across the transverse axis and the magnet periodicity is likewise maintained between neighboring magnet pairs. The undulator 830 is used to oscillate a plurality of independent electron bunches, traveling along multiple trajectories to generate radiation at a wavelength that is proportional to the undulator period, undulator magnetic strength, and the electron beam energy in order to yield the desired wavelengths given the undulator configurations. That is, the undulator 830 comprises a single common collection of alternating polarity magnet pairs that oscillate electron bunches along parallel trajectories, dispersed at equidistance along the transverse dimension of the undulator 830. In one embodiment, the number of electron beam paths, and therefore the number of EUV beams, is equivalent to the number of target applications.

The undulator 830 may be a transversely elongated undulator. The undulator 830 is configured to receive a plurality of parallel electron beams from the electron beam separation module 820. Each of the parallel electron beams are simultaneously processed by the undulator 830. After processing by the undulator 830, the generated radiation comprises a plurality of co-propagating collinear beams 835, each comprised of an electron beam and an EUV beam. That is, the outputs of the undulator 830 are individual parallel beams that each comprises an electron beam component and an EUV beam component. The EUV beam component may be provided to the EUV optics, which then processes the radiation and provides radiation (FEL emission) compatible with photolithography and/or optical metrology purposes. The FEL emission may then be used to perform lithography processing and/or metrology analysis on semiconductor wafers.

The parallel collinear beams 835 are provided to the optical and electron beam separation unit 840. The optical and electron beam separation unit 840 is capable of separating the electron beam component and the EUV beam component from each of the collinear beams 835. The recovered electron beam component from the optical and electron beam separation unit 840 is provided to a disposition system 850 including an electron beam dump and/or possible a means to recover the electron beam energy, which is capable of recovering the electron beam energy by decelerating the beam in an electron accelerator. In some embodiments, this electron accelerator may be the same accelerator unit used to initially accelerate the electron bunches. The disposition system 850 may comprise an electron dump and/or other components capable of recovering electron beam energy.

The EUV beam component 845 of the parallel collinear beams 835 from the optical and electron beam separation unit 840 is provided to the EUV beam routing unit 730. In one embodiment, the EUV beam routing unit 730 is not part of the EUV beam unit 710. In an alternative embodiment, the EUV routing unit 730 may be a part of the EUV beam unit 710.

The EUV beams from the optical and electron beam separation unit 840 is routed to plurality of targets, i.e., a 1^{st} through N^{th} targets 740. That is, the separated plurality of EUV beams are provided to various lithography processing tools and/or metrology tools in the fab 720. More detailed descriptions of the EUV beam routing unit 730 are provided in FIGS. 10 and 11, as well as their respective accompanying descriptions below.

The electron beam source 810 may be comprised of a linear accelerator (linac) in one embodiment, and may be comprised of multi-pass accelerators in another embodiment. FIG. 9A illustrates a stylized block diagram depiction of the electron beam source 810 comprising at least one multi-pass accelerator in accordance with embodiments herein, is illustrated. As depicted in FIG. 9A, the electron beam source 810 may comprise one or more accelerator vaults 910 that are capable of accelerating electron bunches to relativistic velocities. The electron bunches may then be used for generating an EUV beam and/or light energy that may be converted into a light source useful for the operation of a semiconductor processing tool and/or a metrology tool.

For ease of description, only one accelerator vault 910 is illustrated in FIG. 9A; however the electron beam source 810 may comprise a plurality of accelerator vaults. The accelerator vaults 910 of the electron beam source 810 may comprise a multi-pass accelerator 920 for accelerating electrons bunches provided by an electron source 905, as indicated by the curved arrow from an electron source 905 (for some embodiments, this may be an electron injector) and the multi-pass accelerator 920. In some embodiments the acceleration unit(s) 920 may be superconducting in nature. For simplicity, superconducting accelerators 120 are described in this disclosure. The multi-pass accelerator 920 may be a superconducting accelerator that is capable of accelerating the electron bunches to relativistic velocities. In some embodiments, the multi-pass accelerator 920 comprises a plurality of cryomodules, each containing at least one SRF cavity comprising an accelerator unit, through which the electrons are routed during the possible multiple passes of the electrons.

Although use of a multi-pass linear accelerator (linac) is not necessary for the current disclosure as the traditional linear accelerator and FEL configuration 100 is likewise applicable with embodiments presented herein, the multi-pass linac, and specifically recirculation, enforce increased restrictions on the electron beam after FEL emission in an undulator.

The electron beam source 810 may also comprise, or may be coupled, to a cryogen plant 930 that is capable of provide sufficient cooling for the operation of the multi-pass accelerator 920 and its plurality of cryomodules. The electron beam source 810 may also comprise, or may be coupled, a plurality of coolant recovery tanks 970 (e.g., He/N₂ tanks) for recovering coolant material during normal operations as well as possible quenching of the superconducting cavities.

The electron paths (indicated by curved arrows) within multi-pass accelerator 910 may provide electron paths that are equivalent to standard linear path for a FEL source. In an alternative embodiment, a linear arrangement comprising a standard linear path may be utilized by the electron beam source 810. The path of the electrons and the number of accelerating units 120 may be manipulated so that sufficient electron beam energy is obtained while reducing the linear length required for operations of the electron beam source 810. The output of the electron beam source 810 is an electron beam 805 that may operate at various repetition rates and pulse structures (e.g., macro/micro or single bunch mode) as determined necessary to deliver the required FEL emission output power.

FIG. 9B illustrates a stylized depiction of multi-pass accelerator 920 of FIG. 9A, in accordance with embodiments herein. The multi-pass accelerator 920 utilizes a circulating electron beam path 955, which passes through possibly multiple sets of accelerating units 950 as well as magnet bend assemblies 960. Electron bunches are provided to electron beam path 955 by the electron source 905.

The magnet bend assemblies 960 are utilized to steer the electron beam along the denoted beam path 955. Passing an electron (bunch) through a dipole magnet causes its trajectory to bend according to the Lorentz force. After the electron beam has reached the targeted energy (relativistic velocity), the beam path 955 is directed out of the multi-pass accelerator 920 to an undulator.

Turning now to FIG. 10, a stylized depiction of one embodiment of implementing the transversely elongated undulator system of FIG. 8, is illustrated. The electron beam source 810 provides an electron beam to the electron beam splitting module 820. In one embodiment, the electron beam splitting module 820 comprises a 1^{st} variable dipole bend magnet 1010 (“1^{st} magnet 1010”) and a 2^{nd} variable dipole bend magnet 1020 (“2^{nd} magnet 1020”). The module 820 may also comprise a 1^{st} voltage source 1015 for controlling the strength of the 1^{st} magnet 1010, and a 2^{nd} voltage source 1015 for controlling the strength of the 2^{nd} magnet 1010. In one embodiment, the 1^{st} and 2^{nd} magnets 1010, 1020 are synchronized. In some embodiments, the dipole magnets 1010 and 1020 may be synchronized through a control device, such as a computer or other automated instrumentation for providing continuous feedback.

The 1^{st} magnet 1010 is configured to bend the electron beam by a first angle (e.g., 45°). The 1^{st} magnet 1010 is also capable of splitting the electron beam into multiple electron beams, as stylized in FIG. 10. In one embodiment, the 1^{st} and 2^{nd} magnets 1010, 1020 are voltage controlled magnets. That is, the magnetic field strengths of the 1^{st} and 2^{nd} magnets 1010, 1020 may be varied by changing a voltage input provided to the 1^{st} and 2^{nd} magnets 1010, 1020. The 1^{st} voltage source 1015 is capable of providing a 1^{st} variable voltage signal for controlling the magnetic field strength of the 1^{st} magnet 1010. The strength of the magnetic field may be manipulated to control the trajectory of the electron beam, which allows for splitting the input electron beam into a plurality of split electron beams.

The separated or split electron beams are then directed to the 2^{nd} magnet 1020. The 2^{nd} magnet 1020 is capable of bending the plurality of the split electron beams by a 2^{nd} angle. The 2^{nd} angle may be equal and opposite of the 1^{st} angle. The magnetic field strength of the 2^{nd} magnet 1020 may be varied by changing a voltage input provided to the 2^{nd} magnet 1025. The 2^{nd} voltage source 1025 is capable of providing a 2^{nd} variable voltage signal for controlling the magnetic field strength of the 2^{nd} magnet 1025. The variation between the 1^{st} and 2^{nd} voltages is sufficiently controlled such that the split electron beams are substantially parallel. The output of the 2^{nd} magnet is a set of split electron beams that are substantially parallel to each other. This set of split electron beams are provided to the undulator 830.

Since the high-current electron beam is divided into the set of split electron beams prior to being provided to the undulator 830, the individual, split electron beams may be independently conditioned for generating multiple EUV beams of lesser power (as compared to a single EUV beam of much higher power). In this manner, the undulator 830 is capable of creating multiple kilo Watt (kW)-class EUV beams independently of each other. The division of the electron beam prior to being provided into the undulator 830 provide for a stress reduction on downstream EUV optical elements as well as the undulator itself, i.e. reduction of resistive wall heating and radiation damage of the magnets. The output of the undulator 830 comprises multiple beams that each has a EUV beam component as well as an electron beam component.

The multiple EUV beam outputs from the undulator 830 are parallel to each other and comprise an intrinsic spacing between each other. This spacing between the multiple EUV beam outputs from the undulator 830 are based upon the spacing of the electron beams 825 delivered by the dipole magnet splitting system 820 to undulator 830. The transverse dimension of the undulator 830 is determined by the number of electron beams as well as the necessary spacing between the beams to mitigate beam interference as well as minimize resistive wall heating. The undulator 830 comprises a plurality sets of strategically spaced magnet assemblies 835 of alternating polarity. These magnet assemblies 835 in the undulator 830 are arranged with an undulator period and have a magnetic strength parameters for a particular electron beam energy to deliver the desired output emission wavelength, taken to be in the EUV for the purposes of this disclosure. The magnet assemblies in the undulator 830 is used to oscillate the electron bunches 825 to generate radiation that is proportional to the undulator period, undulator magnetic strength, and the electron beam energy provided by the corresponding SRF cavities to yield the desired wavelength given the configuration of each undulator assembly 830. The spacing between the parallel electron beams 825 provides for the spacing between the EUV beams 835 from the undulator 830. This spacing is chosen to facilitate efficient distribution of the EUV beams to multiple targets (optical processing tools and/or optical metrology tools). The spacing of the EUV beams 835 is chosen for easy integration of an EUV beam routing unit 730, i.e. the placement of the optical elements within the EUV beam routing unit 730. This distribution can be performed without having to employ undulator switchyards and the complexities and costs associated with bunch continuity between undulators.

The output from the undulator 830 is directed to the optical and electron beam separation unit 840. The optical and electron separation unit 840 may comprise a 3^{rd} variable dipole bend magnet 1030 magnet 1030 (“3^{rd} magnet 1030”) and a 4^{th} variable dipole bend magnet 1040 (“4^{th} magnet 1040”). In one embodiment, the 3^{rd} and 4^{th} magnets 1030, 1040 are voltage controlled magnets. The optical and electron separation unit 840 may also comprise a 3^{rd} voltage source 1035 for controlling the strength of the 3^{rd} magnet 1030, and a 4^{th} voltage source 1045 for controlling the strength of the 4^{th} magnet 1040. In one embodiment, the 3^{rd} and 4^{th} magnets 1030, 1040 are synchronized. In some embodiments, the 1^{st} through 4^{th} magnets (1010, 1020, 1030, 1040) are all synchronized.

As noted above, the output of the undulator 830 has two components: an electron beam component and an EUV beam component. The 3^{rd} magnet 1030 redirects the path of the electron beam component of the output of the undulator 830 by a 3^{rd} angle (e.g., 45°). Meanwhile, the EUV beam component of the output is undisturbed by the 3^{rd} magnet 1030, and thus, continues onwards to the EUV beam routing unit 730.

The electron beam component of the output of the 3^{rd} magnet 1030 is directed to the 4^{th} magnet 1040. The 3^{rd} and 4^{th} magnets 1030, 1040 operate to combine the electron beam component in a collinear fashion. The combining of the electron beam provide for a reduction in the complexity of a beam dump and the potential energy recovery system (electron beam dump and accelerator cavities for beam deceleration) 850. The output of the 4^{th} magnet 1040 is the combined electron beam that is redirected by a 4^{th} angle (e.g., negative value of the 3^{rd} angle). The path-lengths of the set of the split electron beams are generally equivalent for maintaining the desired electron bunch spacing. The equivalence in path-length is established at the exit of dipole magnet 1040. The electron bunch parameters between bunches having traveled along different paths through the proposed transversely elongated undulator 830 are to be substantially equivalent. The output of the 4^{th} magnet 1040 may be provided to a beam dump either directly or after being processed by an energy recovery system 850 as previously described.

The EUV component of the output of the undulator 830 passes through the 3^{rd} magnet 1030 and onto the EUV beam routing unit 730. The EUV component comprises a plurality of separate EUV beams that are parallel to each other and are separated by a predetermined spacing equivalent to the electron beam spacing within the undulator 830, i.e. the electron and optical beams are collinear within the undulator. In one embodiment, the EUV beams may be of the same power, while in other embodiments, the power of each of the EUV beams may vary. For example, EUV beams of a 1^{st} power may be provided to photolithography tools, while EUV beams of a 2^{nd} power may be provided to optical metrology tools. This is accomplished by varying the electron beam current along the various trajectories within the undulator 830 via the number of electron bunches that are directed along each trajectory by dipole magnet 1010. The bunches may be directed along each trajectory on a bunch-by-bunch basis or possible in a macro/micro pulse basis, depending on the FEL operational mode. In some embodiments, sets of bunches may also be sent along each trajectory at an reduced integer repetition rate of the main electron source 810 repetition rate.

The EUV beam routing unit 730 is capable of routing the EUV beams to different targets (e.g., processing tools, metrology tools, etc.). The EUV beam routing unit 730 may comprise various types of optical signal-directing apparatus. For example, the EUV beam routing unit 730 may comprise a plurality of incidence mirrors and/or other reflective objects 1050 (e.g., grazing incidence metal mirrors) that are capable of directing the EUV beams to various targets. In one embodiment, the reflective feature of the incidence mirrors/reflective objects may be comprised of a metallic material or a substrate coated with a plurality of alternating materials (e.g., Mo/Si multi-layer mirror capable of near-normal incidence reflection) optimized for desired wavelength. The incidence mirrors/reflective objects 1050 of the EUV beam routing unit 730 may be controlled by various types of control systems 1070 known to those skilled in the art having benefit of the present disclosure, allowing for dynamic controls with regard to the direction of the EUV beams. In one embodiment, the control system 1070 may individually control each of the reflective objects 1050 individually for directing predetermined EUV beams to selected targets.

Turning now to FIG. 11, a stylized depiction of an alternative embodiment of implementing the transversely elongated undulator system of FIG. 8, is illustrated. The electron beam source 810 provides an electron beam to the electron beam splitting module 820. In one embodiment, the electron beam splitting module 820 comprises a 1^{st} set of radio-frequency (RF) deflecting cavities 1110 (“1^{st} RF cavity 1110”) and a 2^{nd} set of RF deflecting cavities 1120 (“2^{nd} RF cavity 1120”). The 1^{st} and 2^{nd} cavities 1110, 1120 operate to split the input electron beam into a plurality of split electron beams. In one embodiment, the 1^{st} and 2^{nd} cavities 1110, 1120 form a “kicker” combination of a splitter and a merger, respectively. This kicker combination of the splitter and merger are capable of generating multiple parallel electron beam from a single, more powerful electron beam. As the RF phase of the 1^{st} and 2^{nd} cavities 1110, 1120 varies, electrons are “kicked” in proportion to the variation of the RF phase. Equal but opposite RF phases will “kick” the electrons equally in force, but in opposite directions. The outputs of the 1^{st} and 2^{nd} cavities 1110, 1120 are a plurality of split electron beams.

The separated/split electron beams are then directed to a 5^{th} dipole magnet 1130 (“5^{th} magnet 1130”). In one embodiment, the 5^{th} dipole magnet 1130 is a permanent magnet. The 5^{th} magnet 1130 is capable of bending the plurality of the split electron beams by a 5^{th} angle (e.g., 45°) such that the split electron beams are provided to the undulator 830 in a straight, parallel format.

Similar to the previous embodiment described above, since the high-current electron beam is divided into the set of split electron beams prior to being provided to the undulator 830, the individual, split electron beams may be independently conditioned for generating multiple EUV beams of lesser power (as compared to a single EUV beam with higher power). The multiple EUV beam outputs from the undulator 830 are parallel to each and comprise an intrinsic spacing between each other. The spacing between the multiple EUV beam outputs from the undulator 830 are based upon the configuration of the undulator 830. The output from the undulator 830 is directed to the optical and electron separation unit 840.

In the embodiment of FIG. 11, the optical and electron separation unit 840 may comprise a 6^{th} dipole bend magnet 1140 (“6^{th} magnet 1140”), a 2^{nd} set of RF deflecting cavities 1150 (“3^{rd} RF cavity 1150”) and a 4^{th} set of RF deflecting cavities 1160 (“4^{th} RF cavity 1160”). In one embodiment, the 6^{th} dipole magnet 1140 is a permanent magnet.

Similar to the embodiment above, the output of the undulator 830 has two components: an electron beam component and an EUV beam component. The 6^{th} magnet 1140 redirects the path of the electron beam component of the output of the undulator 830 by a 6^{th} angle (e.g., 45°). The EUV beam component of the output is undisturbed by the 6^{th} magnet 1140, and continues onwards to the EUV beam routing unit 730.

The electron beam component from the 6^{th} magnet 1140 is directed to the 3^{rd} RF cavity 1150 and the 4^{th} RF cavity 1160. The 3^{rd} and 4^{th} RF cavities 1150, 1160 operate to combine the electron beam component in a collinear fashion, which are provided to the beam dump/potential energy recovery system 850. After exiting the last SRF deflection cavity 1160, the path-lengths of the individual electron beams 825 having traversed the transversely elongated undulator 830 are equivalent and the electron bunch parameters are substantially equivalent. Similar to the embodiment of FIG. 10, the EUV beam routing unit 730 of FIG. 11 is capable of routing the EUV beams to different targets (e.g., processing tools, metrology tools, etc.). The EUV beam routing unit 730 may comprise a plurality of incidence mirrors and/or other reflective objects 1050 (e.g., grazing incidence metal mirrors) that are capable of directing the EUV beams to various targets. In this manner, EUV beams of different power and/or similar power may be provided to a variety of targets, such as processing tool and/or metrology tools.

The incidence mirrors/reflective objects 1050 of the EUV beam routing unit 730 may be controlled by various types of control systems 1070 known to those skilled in the art having benefit of the present disclosure, allowing for dynamic controls with regard to the direction of the EUV beams. In one embodiment, the control system 1070 may individually control each of the reflective objects 1050 individually for directing predetermined EUV beams to selected targets.

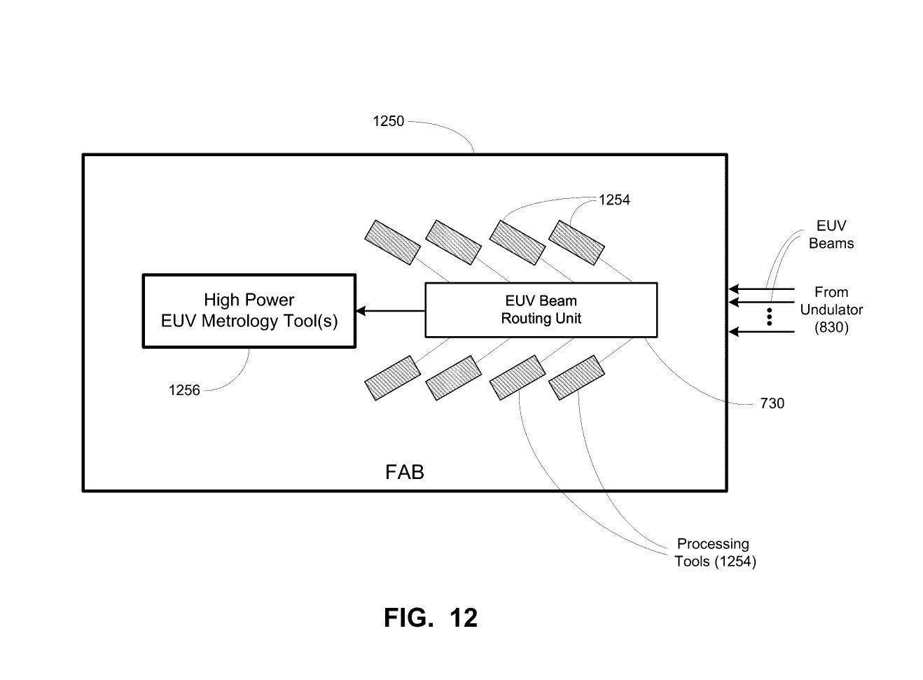

FIG. 12 illustrates a stylized depiction of a fab 1250 in accordance with embodiments herein. In one embodiment, the EUV beam routing unit 730 may be part of the fab 1250. The EUV beam routing unit 730 beam receives a plurality of EUV beams from the undulator 830.

The fab 1250 may also comprise a plurality of processing tools 1254 that comprise EUV scanners. The processing tools 1254 are capable of using the light energy provided by the EUV beam routing unit 730 to perform processing operations (e.g., photolithography processes) on semiconductor wafers

The fab 1250 may also comprise a plurality of EUV metrology tools 1256. Some of the EUV beams from the EUV beam routing unit 730 may be provided to the metrology tools 1256. The metrology tools 1256 are capable of performing inspection on processed semiconductor wafer using EUV radiation.

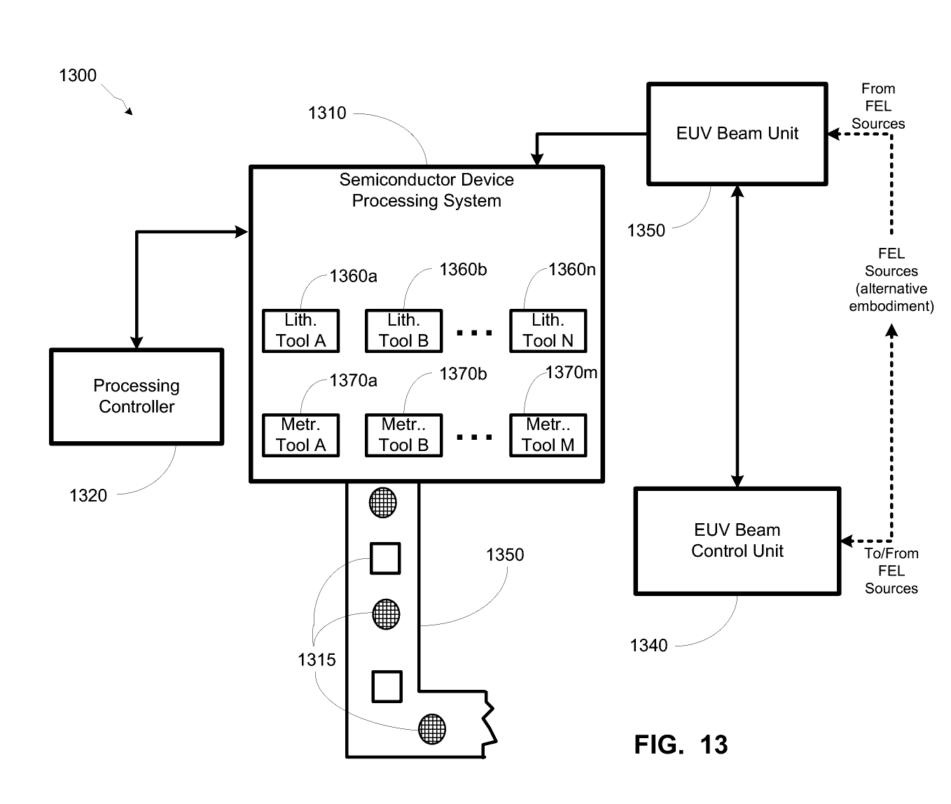

Turning now to FIG. 13, a stylized depiction of a system for providing an EUV beam for processing and inspecting semiconductor wafers, in accordance with embodiments herein, is illustrated. A semiconductor device processing system 1310 may manufacture integrated circuit devices by processing semiconductor wafers. The semiconductor device processing system 1310 may comprise various processing stations, such as etch process stations, photolithography process stations, CMP process stations, etc. The semiconductor wafers processed by these tools may be analyzed by metrology tools in the processing system 1310.

The processing system 1310 of FIG. 13 may comprise a plurality of lithography tools (1260a-1260n) that use EUV beams to perform lithography processing of semiconductor wafers. Further, the processing system 1310 may also comprise a plurality of metrology tools (1270a-1270m) that are capable of using light energy to perform metrology inspection of semiconductor wafers.

The system 1300 may comprise an EUV beam unit 1350 that is capable of providing one or more EUV beams for use by various lithography tools 1360a-1260n and metrology tools 1370a-1270m in the processing system 1310. In one embodiment, the EUV beam unit 1350 is capable of generating a FEL beam and is capable of dividing and distributing the EUV beams to the lithography tools 1360a-1260n. In an alternative embodiment, as indicated by the dotted lines in FIG. 13, the EUV beam unit 1350 may receive an EUV beam from a FEL system. The EUV beam control unit 1350 is capable of controlling the operations of the EUV beam unit 1350. For example, the switching and distribution of the EUV beam to various locations in the processing system 1300 may be controlled by the EUV beam control unit 1340. Further, the EUV beam control unit 1340 may receive data indicative of the operations of a FEL system and make adjustments to the usage of the EUV beams as a result.

One or more of the processing steps performed by the processing system 1310 may be controlled by the processing controller 1320. The processing controller 1320 may be a workstation computer, a desktop computer, a laptop computer, a tablet computer, or any other type of computing device comprising one or more software products that are capable of controlling processes, receiving process feedback, receiving test results data, performing learning cycle adjustments, performing process adjustments, etc.

The semiconductor device processing system 1310 may produce integrated circuits on a medium, such as silicon wafers. The production of integrated circuits by the device processing system 1310 may be based upon the circuit designs provided to the processing controller 1320. The processing system 1310 may provide processed integrated circuits/devices 1315 on a transport mechanism 1350, such as a conveyor system. In some embodiments, the conveyor system may be sophisticated clean room transport systems that are capable of transporting semiconductor wafers. In one embodiment, the semiconductor device processing system 1310 may comprise a plurality of processing steps, e.g., the 1^{st} process step, the 2^{nd} process set, etc., as described above.

In some embodiments, the items labeled “1315” may represent individual wafers, and in other embodiments, the items 1315 may represent a group of semiconductor wafers, e.g., a “lot” of semiconductor wafers. The integrated circuit or device 1315 may be a transistor, a capacitor, a resistor, a memory cell, a processor, and/or the like. In one embodiment, the device 1315 is a transistor and the dielectric layer is a gate insulation layer for the transistor.

The system 1300 may be capable of performing analysis and manufacturing of various products involving various technologies. For example, the system 1300 may design and production data for manufacturing devices of CMOS technology, Flash technology, BiCMOS technology, power devices, memory devices (e.g., DRAM devices), NAND memory devices, and/or various other semiconductor technologies.

The system 1300 may be capable of manufacturing and testing various products that include transistors with active and inactive gates involving various technologies. For example, the system 1300 may provide for manufacturing and testing products relating to CMOS technology, Flash technology, BiCMOS technology, power devices, memory devices (e.g., DRAM devices), NAND memory devices, and/or various other semiconductor technologies.

The methods described above may be governed by instructions that are stored in a non-transitory computer readable storage medium and that are executed by, e.g., a processor in a computing device. Each of the operations described herein may correspond to instructions stored in a non-transitory computer memory or computer readable storage medium. In various embodiments, the non-transitory computer readable storage medium includes a magnetic or optical disk storage device, solid state storage devices such as flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method comprising:
receiving a first electron beam;
converting said first electron beam into at least a second electron beam and a third electron beam;
providing said at least second and third electron beams to an undulator;
generating, by said undulator, a plurality of output beams using said at least second and third electron beams, said output beams respectively comprising a plurality of optical beam components and a plurality of electron beam components; and
providing a first optical beam component from said plurality of optical beam components to a first processing tool.

2. The method of claim 1, further comprising:
providing a second optical beam component from said plurality of optical beam components to a second processing tool; and
providing a third optical beam component from said plurality of optical beam components to a metrology tool

3. The method of claim 2, wherein:
providing said first optical beam component comprises providing a first extreme-ultraviolet (EUV) beam;
providing said second optical beam component comprises providing a second EUV beam; and
providing said third optical beam component comprises providing a third EUV beam.

4. The method of claim 1, wherein receiving a first electron beam comprises receiving said first electron beam from at least one of a linear electron accelerator or a multi-pass linear electron accelerator.

5. The method of claim 1, wherein said generating, by said undulator, a plurality of output beams, by a transversely-elongated undulator comprising a plurality of sets of magnets for converting said electron beams to said plurality of output beams.

6. The method of claim 1, wherein further comprising separating said electron beam component from the output beam and providing said electron beam component to a disposition system comprised of at least one of an electron beam dump and electron beam recovery unit comprising a decelerator in at least one RF cavity.

7. The method of claim 6, wherein separating said electron beam component from the output beam comprises using a first variable dipole magnet to separate electrons from said optical component of said output beam to generate a plurality of parallel electron beams.

8. The method of claim 7, wherein providing said electron beam component to said electron beam disposition system comprises using at least one of a second variable dipole magnet or a radio frequency (RF) deflecting cavity to converge said plurality of parallel electron beams into a single electron beam.

9. The method of claim 1, wherein converting said first electron beam into at least said second electron beam and said third electron beam comprises using a first dipole magnet and a second dipole magnet to split said first electron beam into said second and third electron beam in a parallel path.

10. A device, comprising:
an electron beam separation module configured to receive a first electron beam and splitting the first electron beam into a plurality of split electron beams;
an undulator operatively coupled with said electron beam separation module, said undulator configured to convert said plurality of split electron beams to a plurality of output beams each comprising an optical beam component and an electron beam component; and
a beam separation unit operatively coupled to said undulator, said beam separation unit configured to separate said electron beam components from said output beam.

11. The device of claim 10, further comprising an electron beam source configured to generate said electron beam.

12. The device of claim 10, further comprising at least one of:
an electron dump for receiving said electron beam components;
a feedback component for providing a feedback of the electron beam components to said electron beam source; and
an electron acceleration system.

13. The device of claim 10, wherein said undulator is a transversely-elongated undulator comprising a plurality of sets of magnets for converting said electron beams to said plurality of output beams.

14. The device of claim 10, wherein said electron beam separation module comprises:
a first dipole magnet to change the direction of said electron beam and convert said electron beam into said plurality of split electron beams; and
a second dipole magnet to change the direction of said split electron beams to provide said split electron beams to said undulator in a parallel format.

15. The device of claim 14, wherein said first and second dipole magnets are variable magnets that are each controlled by a voltage input, and wherein the electron beam current may be controlled by at least one of said first or second dipole magnets.

16. The device of claim 10, wherein said beam separation unit comprises:
a first radio-frequency (RF) deflecting cavity and a second RF deflecting cavity configured to convert said electron beam into said plurality of split electron beams; and
a first dipole magnet to change the direction of said split electron beams to provide said split electron beams to said undulator in a parallel format.

17. A system, comprising:
a semiconductor device processing system to process and inspect semiconductor wafers, said semiconductor device processing system comprising a plurality of optical processing tools and at least one optical metrology tool:
a processing controller operatively coupled to said semiconductor device processing system, said processing controller configured to control an operation of said semiconductor device processing system; and
an optical beam unit for providing a plurality of optical beams to said semiconductor device processing system said optical processing tools, said optical beam unit comprising:
an electron beam separation module configured to receive a first electron beam and splitting the first electron beam into a plurality of split electron beams;
an undulator operatively coupled with said electron beam separation module, said undulator configured to convert said plurality of split electron beams to a plurality of output beams each comprising an optical beam component and an electron beam component; and
a beam separation unit operatively coupled to said undulator, said beam separation unit configured to separate said electron beam components from said output beam.

18. The system of claim 17, wherein said optical beams are extreme ultraviolet (EUV) laser beams.

19. The system of claim 17, wherein said electron beam separation module comprises:
a first radio-frequency (RF) deflecting cavity and a second RF deflecting cavity configured to convert said electron beam into said plurality of split electron beams, and wherein the electron beam current is controlled by at least one of said first RF deflecting cavity or said second RF deflecting cavity; and
a first variable dipole magnet to change the direction of said split electron beams to provide said split electron beams to said undulator in a parallel format.

20. The system of claim 17, wherein said beam separation unit comprises:
a first dipole magnet to change the direction of said electron beam and convert said electron beam into said plurality of split electron beams; and
a second dipole magnet to change the direction of said split electron beams to provide said split electron beams to said undulator in a parallel format.
